(19) United States
(12) Patent Application Publication
(10) Pub. No.: US 2007/0171592 A1
(43) Pub. Date: Jul. 26, 2007

(54) Device for removing static charge

(76) Inventor: Wen Sung Lee, Taichung City (TW)

Correspondence Address: BANGER SHIA, 204 CANYON CREEK, VICTORIA, TX, 77901-3695, US

(21) Appl. No.: 11/339,856

(22) Filed: Jan. 26, 2006

(51) Int. Cl. H05F 3/00

(52) U.S. Cl. 361/220

(57) ABSTRACT

Disclosed is a device is for removing static charge. The device includes a shell, a lead, a circuit board, at least one warning signal and a power supply. The shell includes a conductive portion. The lead is for contact with an external object that carries static charge. The circuit board is connected to the lead on one hand and connected to the conductive portion of the shell on the other hand. The circuit board is installed in the shell. The warning signal is installed on the shell. The power supply is connected to the circuit board. On detecting electric current caused by the removal of the static charge, the circuit board instructs the power supply to stably energize the warning signal no matter how weak the electric current may be.

### BACKGROUND OF INVENTION

1. Field of Invention

The present invention relates to a device for removing static charge and, more particularly, to a device for removing static charge while providing a stable warning and illumination.

2. Related Prior Art

In a dry environment, different materials provide different ability to attract electrons. When two different materials rub against each other, the electrons of one of the materials will be attracted to the other material. That is, one of the materials is positively charged while the other material is negatively charged. There is static charge. On touching static charge, a person gets shocked. On the moment a delicate electronic device is brought into contact with static charge, it might be activated by mistake or damaged. In the most dangerous occasions, flame and/or explosion might be incurred. It is important to warn and prevent the emergence of static charge. To this end, there have been various devices for removing static charge. Some examples can be found in Published Taiwanese Patent Application No. 200410601 and Taiwanese Patent Publication Nos. 516766, 492355 and 439705.

To warn a user of the existence of static charge on an object, some of the devices are equipped warning signals or lights. The operation of the warning signals is based on circuits for using static charge to energize the warning signals. However, before all of the static charge is removed, its residual might have become too little to energize the warning signals, thus providing a false indication that all of the static charge has been removed. In some other cases, the static charge is too little to energize the warning signals from the very beginning. Thus, the static charge is not detected at all. The static charge will continue to accumulate and might have reached a dangerous level by the time a next check is run.

The present invention is therefore intended to obviate or at least alleviate the problems encountered in prior art.

### SUMMARY OF INVENTION

It is an objective of the present invention to provide a device for removing static charge while providing a stable warning.

According to the present invention, a device is for removing static charge includes a shell, a lead, a circuit board, at least one warning signal and a power supply. The shell includes a conductive portion. The lead is for contact with an external object that carries static charge. The circuit board is connected to the lead on one hand and connected to the conductive portion of the shell on the other hand. The circuit board is installed in the shell. The warning signal is installed on the shell. The power supply is connected to the circuit board. On detecting electric current caused by the removal of the static charge, the circuit board instructs the power supply to stably energize the warning signal no matter how weak the electric current may be.

It is another objective of the present invention to provide a device for removing static charge while providing illumination.

To this end, the present invention includes a light connected to the circuit board so that the power supply can energize the light.

Other objectives, advantages and features of the present invention will become apparent from the following description referring to the attached drawings.

### BRIEF DESCRIPTION OF DRAWINGS

The present invention will be described through detailed illustration of the preferred embodiment referring to the drawings.

FIG. 1 is a perspective view of a device for removing static charge according to the preferred embodiment of the present invention.

FIG. 2 is an exploded view of the device shown in FIG. 1.

FIG. 3 is a perspective partial view of the device shown in FIG. 2.

FIG. 4 is another perspective partial view of the device of FIG. 2.

FIG. 5 is perspective bottom view of the device shown in FIG. 2.

FIG. 6 is a diagram of a circuit used in the device shown in FIG. 2.

### DETAILED DESCRIPTION OF PREFERRED EMBODIMENT

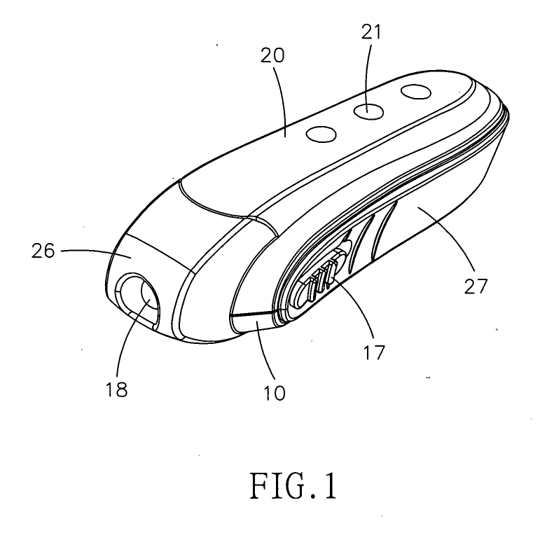

Referring to FIG. 1, there is shown a device for removing static charge according to the preferred embodiment of the present invention. The device includes a shell consisting of a lower cover 10, an upper cover 20, a conductive front cover 26 and a conductive lateral cover 27. A switch 17 is installed on the conductive lateral cover 27. The switch 17 is however isolated from the conductive lateral cover 27. A light 18 is installed on the conductive front cover 26. The light is however isolated from the conductive front cover 26. A plurality of windows 21 are installed on the upper cover 20.

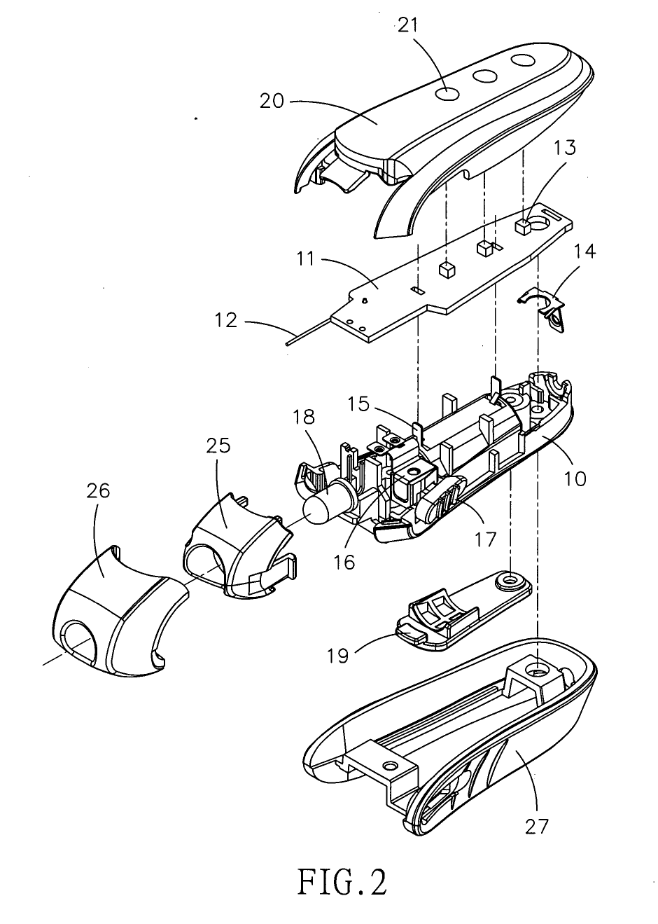

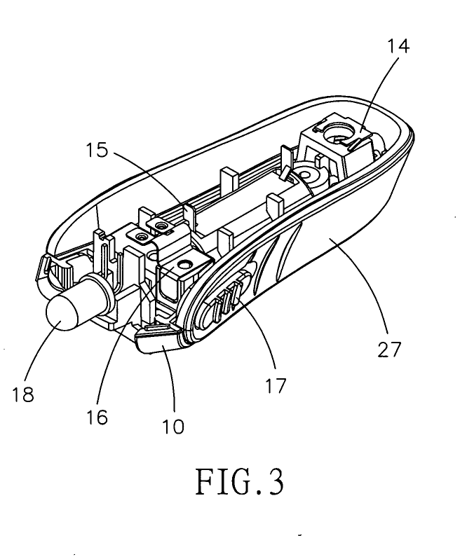

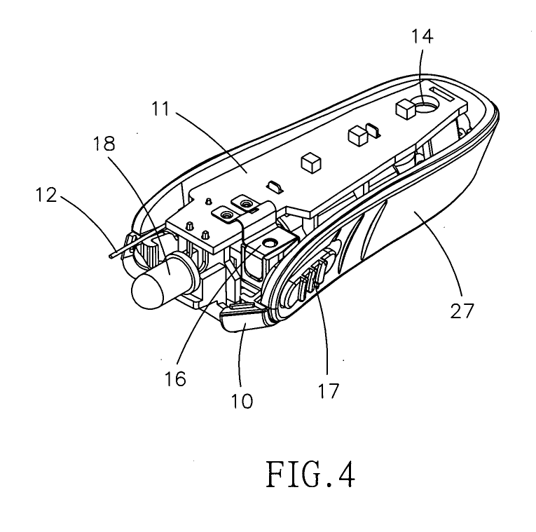

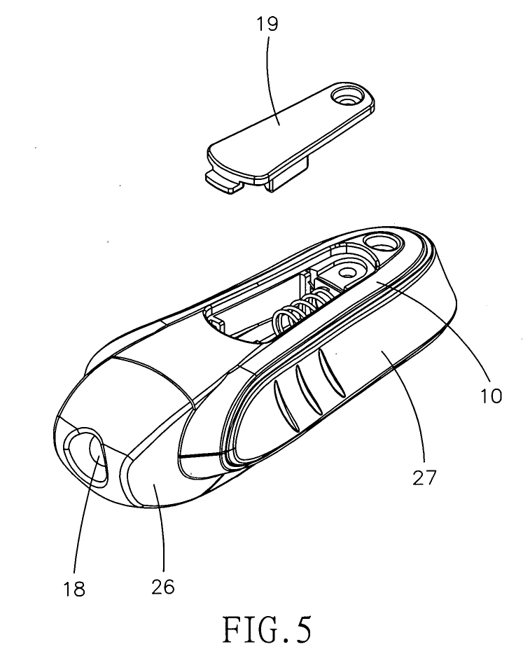

Referring to FIGS. 2 through 5, the device includes a circuit board 11 installed on the lower cover 10, a lead 12 extending to the conductive front cover 26 from the circuit board 11 and a connector 14 for connecting the circuit board 11 to the conductive lateral cover 27. A mount 25 is provided between the lower cover 10 and the upper cover 20 and connected to the conductive lateral cover 27. The conductive front cover 26 is installed on the mount 25.

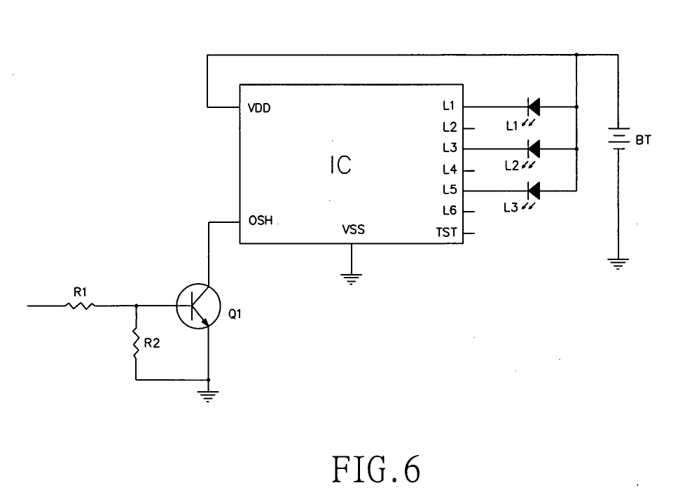

Referring to FIG. 6, the circuit 11 embodies a circuit. The circuit includes a gate element connected to the lead 12 and a microcontroller connected to the gate element.

A series of warning signals 13 is connected to the circuit board 11. The warning signals 13 are in the form of light-emitting diodes (“LED”). The warning signals 13 can be observed through the windows 21.

A light 18 is connected to the circuit board 11. The light 18 can be observed through a window defined in the mount 25 and a window defined in the conductive front cover 26.

A power supply 15 is installed on the circuit board 11. The power supply 15 is preferably in the form of a battery set. Controlled by means of the microcontroller of the circuit embodiment in the circuit board 11, the power supply 15 energized the warning signals 13 and the light 18. The power supply 15 is moved into the shell through an opening defined in the lower cover 10. The opening defined in the lower cover 10 can be closed by means of a shutter 19.

A connector 16 is used to electrically connect the switch 17 to the circuit board 11. Thus, the switch 17 can be operated to turn on and off the light 18.

A user can bring the device into contact with an object that carries static charge while standing on the ground or a floor. The conductive front cover 26 is in contact with the static charge. The lead 18 conducts the static charge to the circuit board 11. The static charge goes from the circuit board 11 to the conductive lateral cover 27 through the connector 14. The static charge goes from the conductive lateral cover 27 to the user's hand. Finally, the static charge goes from the user to the ground or floor. Hence, electric current emerges. On detecting this electric current, the microcontroller of the circuit embodied in the circuit board 11 instructs the power supply 15 to energize the warning signals 13. Even as the electric current gets weaker as the static charge left in the object gets less, the microcontroller of the circuit embodied in the circuit board 11 continues to detect the electric current and instruct the power supply 15 to stably energize the warning signals 13 no matter how weak the electric current may be. The user can turn on and off the light 18 by means of operating the switch 17.

The device of the present invention exhibits at least two advantages. Firstly, it provides a stable warning while removing static charge. It provides illumination while removing static charge.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

1. A device for removing static charge, the device comprising:
a shell comprising a conductive portion;
a lead for contact with an external object that carries static charge;
a circuit board connected to the lead on one hand and connected to the conductive portion of the shell on the other hand, wherein the circuit board is installed in the shell;
at least one warning signal installed on the shell; and
a power supply connected to the circuit board so that on detecting electric current caused by the removal of the static charge, the circuit board instructs the power supply to stably energize the warning signal no matter how weak the electric current may be.

2. The device according to claim 1 comprising a light connected to the circuit board so that the power supply can energize the light.

3. The device according to claim 2 comprising a switch connected to the circuit board so that the switch can be operated to turn on and off the light.

4. The device according to claim 3 comprising a connector for connecting the switch to the circuit board.

5. The device according to claim 1 comprising a connector for connecting the circuit board to the conductive portion of the shell.

6. The device according to claim 1 comprising a plurality of warning signals.

7. The device according to claim 1 wherein the shell comprises at least one window through which the warning signal can be observed.

8. The device according to claim 1 wherein the conductive portion of the shell is a conductive lateral cover for contact with a user's hand.

9. The device according to claim 8 wherein the shell comprises a conductive front cover for contact with the external object, wherein the conductive front cover is connected to the lead.

10. The device according to claim 1 wherein the shell comprises a shutter for closing an opening defined in the shell through which the power supply can be moved into and removed from the shell.

11. The device according to claim 1 wherein the shell comprises a lower cover on which the circuit board is installed, an upper cover engaged with the lower cover and a conductive lateral cover used as the conductive portion thereof, wherein the conductive lateral cover extends around the lower and upper covers.
